(19) United States
(12) Patent Application Publication
(10) Pub. No.: US 2015/0011249 A1
(43) Pub. Date: Jan. 8, 2015

(54) MOBILE DEVICE LOCATION DETERMINATION USING WI-FI SIGNALS

(71) Applicants: Michael Siliski, San Francisco, CA (US); Joseph Hughes, London (GB)

(72) Inventors: Michael Siliski, San Francisco, CA (US); Joseph Hughes, London (GB)

(73) Assignee: GOOGLE INC., Mountain View, CA (US)

(21) Appl. No.: 13/095,199

(22) Filed: Apr. 27, 2011

(51) Int. Cl. H04W 64/00

(52) U.S. Cl. 455/456.6

(57) ABSTRACT

A location of a mobile device is determined using Wi-Fi signals. The location of a moving mobile device may be initially determined using a satellite navigation system. When the speed at which the mobile deice is moving falls below a threshold, a determination is made as to whether Wi-Fi signals are receivable at the mobile device. If Wi-Fi is receivable, Wi-Fi signals are used to determine the location of the mobile device rather than the satellite navigation system. The Wi-Fi signals are continuously or repeatedly used to identify the location of the mobile device until the speed at which the mobile device is moving surpasses the threshold or until Wi-Fi signals are no longer receivable at the mobile device. Since Wi-Fi sensors of mobile devices consume less power than satellite navigation sensors, the power consumption of the mobile device is reduced when mobile device location is determined using Wi-Fi signals.

### BACKGROUND OF THE INVENTION

Mobile devices are equipped with many different sensors that are used to identify device location and/or orientation. Exemplary sensors include satellite navigation system sensors such as global positioning system (GPS) sensors, Wi-Fi sensors, cellular identification sensors, sensors for radio connection to a cellular telephone network, and compass sensors. Each type of sensor exhibits individual strengths and weaknesses.

Wi-Fi may be used to determine the location of stationary devices. In a Wi-Fi system, a user device usually performs a scan every thirty to forty seconds to determine which Wi-Fi access points are available to the device. If the device is in motion, Wi-Fi is not used because a different mobile device sensor that updates more frequently provides a more accurate indication of device location than the less frequently updated Wi-Fi sensor.

A satellite navigation system is commonly relied on for the most precise outdoor positioning of mobile devices in motion because GPS updates approximately every second. However, a GPS receiver may consume power at a much higher rate than other mobile device sensors. For example, a GPS receiver may consume as much as 40 mA when activated, which is generally at a premium in mobile devices. In addition, under certain circumstances (e.g., sky occlusion), the quality of GPS signals received from satellites can drop considerably.

### BRIEF SUMMARY OF THE INVENTION

Aspects of the invention relate generally to the determination of a mobile device location using Wi-Fi signals. The location of the moving mobile device may initially be determined using a satellite navigation system such as GPS. In the event that the speed at which the mobile device is moving falls below a threshold, a determination is made whether Wi-Fi signals are receivable at the mobile device. If Wi-Fi is receivable, the Wi-Fi signals are used to determine the location of the mobile device rather than the satellite navigation system. The Wi-Fi signals are continuously or repeatedly used to identify the location of the mobile device until the speed at which the mobile device is moving surpasses the threshold or until Wi-Fi signals are no longer receivable at the mobile device. Since Wi-Fi sensors of mobile devices consume less power than GPS sensors, the power consumption of the mobile device is reduced when mobile device location is determined using Wi-Fi.

In one aspect, a computer-implemented method includes identifying an initial location of a mobile device using a satellite system. Using a processor of the mobile device and using the satellite system, a first speed at which the mobile device is moving is determined. Using the processor, a determination is made whether the first speed is below a threshold. In the event that the first speed is below the threshold, a subsequent location of the mobile device is identified using Wi-Fi signals. The satellite system is not used to determine the subsequent location of the mobile device.

In another aspect, a computer-implemented method for identifying a location of a mobile device using Wi-Fi signals includes identifying an initial location of a mobile device using a satellite system. A first speed at which the mobile device is moving is higher than a threshold. A determination is made whether a second speed at which the mobile device is moving is less than the threshold. The second speed of the mobile device is determined using a processor of the mobile device. A process by which a subsequent location of the mobile device is identified is changed from the satellite system to a system that uses Wi-Fi signals. The subsequent location of the mobile device is identified using the Wi-Fi signals. The satellite system is not used to determine the subsequent location of the mobile device.

In another aspect, a mobile computing device includes means for identifying an initial location of a mobile device using a satellite system, means for determining a first speed at which the mobile device is moving, means for determining whether Wi-Fi signals are receivable, and means for identifying a subsequent location of the mobile device using the Wi-Fi signals. The means for identifying the subsequent location identifies the subsequent location of the mobile device in the event that the first speed is below a threshold and in the event that Wi-Fi signals are receivable. The means for identifying the initial location of the mobile device is not used to identify the subsequent location of the mobile device.

In another aspect, a computer-implemented method includes identifying an initial location of a mobile device using a Wi-Fi signals. Using a processor of the mobile device and the Wi-Fi signals a first speed at which the mobile device is moving is determined. A determination is made whether the first speed is above a threshold. In the event that the first speed is above the threshold, a subsequent location of the mobile device is identified using a satellite system. The Wi-Fi signals are not used to determine the subsequent location of the mobile device.

### BRIEF DESCRIPTION OF THE DRAWINGS

FIG. 1 is a functional diagram of a system in accordance with an aspect of the invention.

FIG. 2 is a pictorial diagram of the system of FIG. 1.

FIG. 3 is an exemplary flow diagram in accordance with aspects of the invention.

FIG. 4 is an illustration of a mobile device that is moving at a speed that falls below a threshold such that the mobile device's location is identified using Wi-Fi signals, in accordance with aspects of the invention.

FIG. 5 is an illustration of a mobile device that is moving at a speed that surpasses a threshold such that the mobile device's location is identified using a satellite navigation system, in accordance with aspects of the invention.

### DETAILED DESCRIPTION

Satellite navigation systems are commonly used to provide a mobile computing device with navigational guidance. For example, when operating a vehicle, GPS navigational guidance may inform a driver when to turn and provide distances between subsequent course changes. Compared to other mobile device sensors, GPS sensors provide the mobile device with the most reliable and precise information to navigate roadways. The location of the mobile device is updated approximately every second such that the GPS signal determines the precise location of the device and provides accurate guidance. According to one aspect, when the mobile device is moving at a slow speed, other mobile device sensors may be used to identify the device's location in order to avoid excessive power consumption associated with GPS navigational guidance. In some embodiments, Wi-Fi signal strength may be precise enough and may update frequently enough for reliable navigational guidance.

When moving at speeds below a threshold, a mobile device performs an active polling of Wi-Fi access points within range of the device. Usually, the device polls the Wi-Fi access points approximately every thirty to forty-five seconds. The polling of the Wi-Fi access points allows for identification of direction of device movement. As the mobile device moves along a route, the device may store the Wi-Fi access point identifiers for the Wi-Fi access points that are accessed along the route. This data may also be stored at a server for access by mobile devices that subsequently move along the same route.

When a different mobile device is detected to be following approximately the same direction and in approximately the same location as a previous mobile device, the mobile device may retrieve the identifiers for the Wi-Fi access points that the previous mobile device interacted with and stored. The location of the mobile device may then be determined using these known Wi-Fi access points and the predicted direction of device movement rather than wait the thirty to forty seconds to poll and access all Wi-Fi access points in the area. For example, a triangulation calculation may be performed to determine a likely device location every second while still only performing Wi-Fi scans every thirty to forty seconds. Accordingly, the location of the device may be determined with enough accuracy to provide reliable navigation without excessive power drainage.

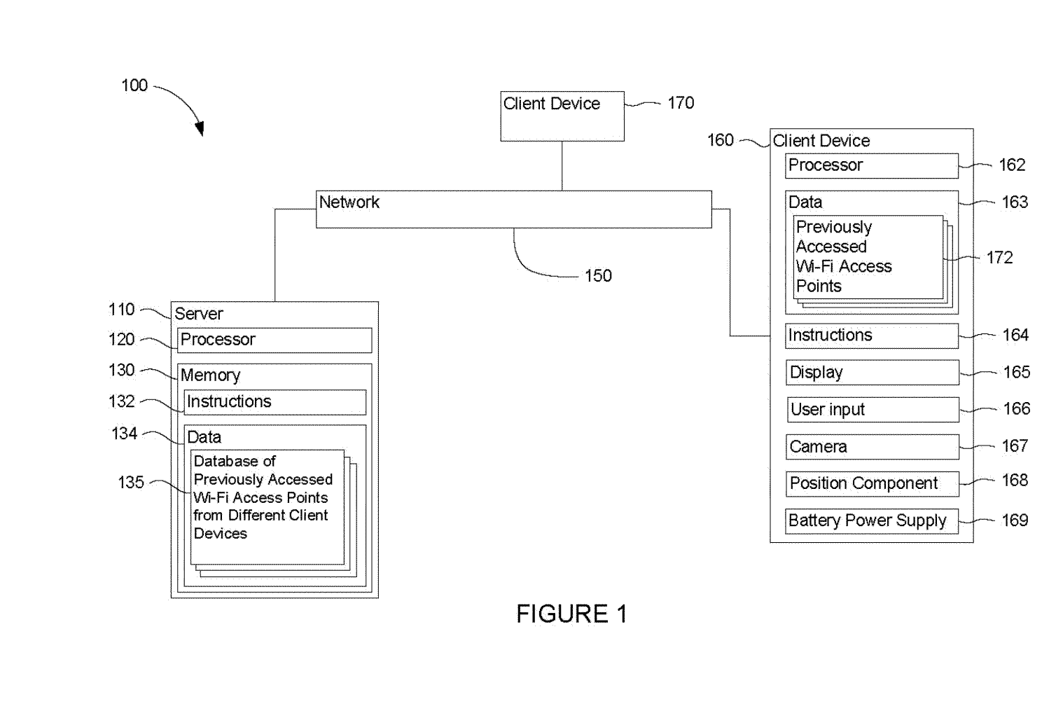

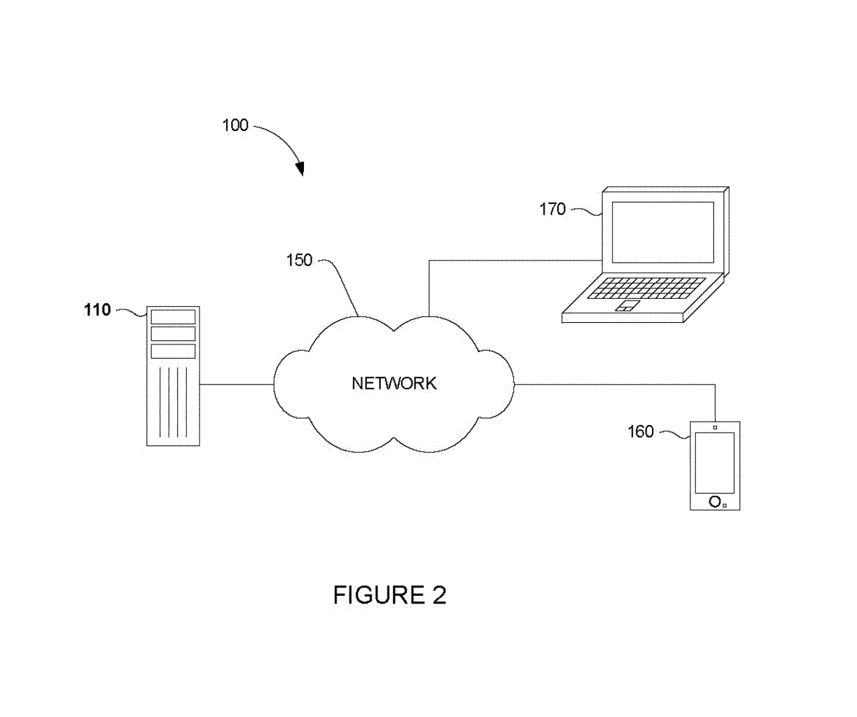

As shown in FIGS. 1 and 2, a system 100 in accordance with one aspect of the invention includes a computer 110 containing a processor 120, memory 130 and other components typically present in general purpose computers. The memory 130 stores information accessible by the processor 120, including instructions 132 and data 134 that may be executed or otherwise used by the processor 120. The memory 130 may be of any type capable of storing information accessible by the processor 120, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by the processor 120 in accordance with the instructions 132. For instance, although the architecture is not limited by any particular data structure, the data 134 may be stored in computer registers, in a relational database as a table having a plurality of different fields and records, XML documents or flat files. The data 134 may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data 134 may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor 120 may be a dedicated controller such as an ASIC. Although FIG. 1 functionally illustrates the processor 120 and memory 130 as being within the same block, it will be understood by those of ordinary skill in the art that the processor 120 and memory 130 may actually comprise multiple processors and memories that may or may not be stored within the same physical housing. For example, memory 130 may be a hard drive or other storage media located in a server farm of a data center. Accordingly, references to a processor, a computer or a memory will be understood to include references to a collection of processors or computers or memories that may or may not operate in parallel.

The computer 110 may be at one node of a network 150 and capable of directly and indirectly receiving data from other nodes of the network. For example, computer 110 may comprise a web server that is capable of receiving data from client devices 160, 170 via network 150 such that server 110 uses network 150 to transmit and display information to a user on display 165 of client device 170. Server 110 may also comprise a plurality of computers that exchange information with different nodes of a network for the purpose of receiving, processing and transmitting data to the client devices 160, 170. In this instance, the client devices 160, 170 will typically be at different nodes of the network than any of the computers comprising server 110.

Network 150, and intervening nodes between server 110 and client devices 160, 170, may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, HTTP and SMTP, and various combinations of the foregoing. Although only a few computers are depicted in FIGS. 1 and 2, it should be appreciated that a typical system can include a large number of connected computers.

Each client device 160 may be a mobile device intended for use by a person, and have all of the components normally used in connection with a mobile computing device such as a central processing unit (CPU) 162, memory (e.g., RAM, internal hard or flash drives) storing data 163 and instructions 164, an electronic display 165 (e.g., a touch-screen or any other electrical device that is operable to display information), and user input 166 (e.g., a small keyboard, keypad, voice recognition, touch screen or microphone). Data 163 of the client device 160 may include a listing 172 of Wi-Fi access points that have been previously accessed by the client device 160. The listing 172 of the previously accessed Wi-Fi access points are also stored at the server 110 in a database 135 of Wi-Fi access points that have been previously accessed by any client devices connected to the network 150.

By way of example only, client device 160 may be a wireless-enabled PDA, a cellular phone, a netbook or a tablet PC capable of obtaining information via the Internet or other network. The client device 160 may also include a camera 167, a geographical position component 168, an accelerometer, speakers, a network interface device, a battery power supply 169 or other power source, and all of the components used for connecting these elements to one another. The client devices 160, 170 may each wirelessly exchange data, including position information derived from the geographical position component 168, with the server 110 over a network such as the Internet.

The geographical position component 168 may be used to determine the geographic location and orientation of the client device 160. For example, the geographical position component 168 may comprise a GPS receiver to determine the device's latitude, longitude and altitude. The geographical position component 168 may also comprise a Wi-Fi sensor, such as a 802.11 compliant RF transceiver, that identifies the location of the client device 160 based on the known locations of Wi-Fi access points that the client device 160 interacts with. Thus, as the client device 160 changes locations, for example by being physically moved, the geographical position component 168 may determine a new current location. The geographical position component 168 may also comprise software for determining the position of the client device 160 based on other signals received at the client device 160, such as signals received at a cellular phone's antennas from one or more cellular phone towers if the client device 160 is a cellular phone.

As discussed in detail below, the geographical position component 168 may also be used to determine the speed at which the client device 170 is travelling. The speed of the client device 170 may vary from 0 meters/second when the device is at rest, to approximately 3 meters/second when a user is walking with the device, to approximately 5-7 meters/second when a user is running with the device, to approximately 7-15 meters/second when a user is cycling with the device, and up to approximately 15-45 meters/second when a user is driving with the device.

In addition to the operations described below and illustrated in the figures, various operations in accordance with aspects of the invention will now be described. It should also be understood that the following operations do not have to be performed in the precise order described below. Rather, various steps can be handled in a different order or simultaneously, and may include additional or fewer operations.

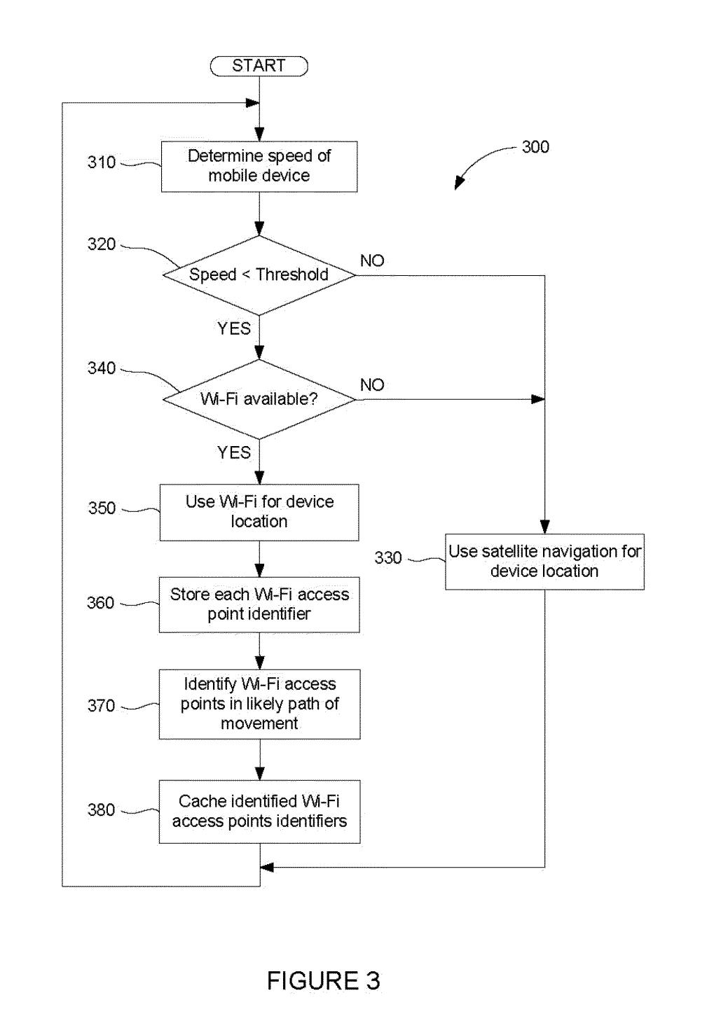

FIG. 3 illustrates a process 300 of using Wi-Fi information to determine a mobile device's location. The process 300 begins when a speed at which the mobile device is moving is determined (step 310). The mobile device is configured with GPS positioning-determining functionality and Wi-Fi functionality. The speed of the mobile device may be determined in a variety of different ways. Many known techniques, such as using GPS readings, triangulation, or a number of handoffs of a call between cellular base stations, rely on the use of one or more network elements for the speed determination. For example, using GPS, the mobile device may send its corresponding location information to a network element at different times. The network element may calculate an average speed of the device by dividing the distance traveled by the time needed to travel that distance. The network element may then return this calculated speed to the mobile device for use by the mobile device.

Several techniques may exist for determining a mobile device's speed that may not rely on any data processing by a network element. For example, one technique may involve the use of a received signal strength indication (RSSI), wherein a mobile device calculates its speed based on the strength of the signals it receives. However, the RSSI technique may consume a great deal of the mobile device's processing capacity and may not work reliably in complex environments, such as urban settings.

Once the speed at which the mobile device is moving is determined, a determination is made as to whether the mobile device's speed exceeds a threshold (step 320). The threshold is selected to be a speed at which Wi-Fi begins to have trouble accurately determining the location of the mobile device. In one embodiment, the threshold is selected to be 15 meters/second. However, the threshold may be selected to be higher or lower than 15 meters/second depending on the accuracy required for mobile device location determination. In the event that the speed at which the mobile device is moving exceeds the threshold, processing proceeds to step 330. In the event that the speed at which the mobile device is moving does not exceed the threshold, processing moves to step 340.

When the speed at which the device is moving exceeds the threshold, satellite navigation techniques are used to determine the location of the mobile device (step 330). A GPS receiver in the mobile device calculates its position by precisely timing the signals sent by GPS satellites. Each satellite continually transmits messages that include: 1) the time the message was transmitted; 2) precise orbital information (e.g., the ephemeris); and 3) the general system health and rough orbits of all GPS satellites (e.g., the almanac). The GPS receiver uses the received messages to determine the transit time of each message and computes the distance to each satellite. These distances along with the satellites' locations are used with the possible aid of trilateration, depending on which algorithm is used, to compute the position of the GPS receiver and the mobile device. Processing then returns to step 310 where the speed and position of the mobile device are continually or repeatedly identified using satellite navigation techniques until the speed at which the mobile device is moving falls below the threshold.

In the event that the speed at which the device is moving falls below or does not exceed the threshold, the mobile device determines if Wi-Fi signals are receivable from its location (step 340). If Wi-Fi signals are not receivable by the mobile device at the speed below the threshold, processing moves to step 330 where the speed and the position of the mobile device are identified using satellite navigation techniques, as discussed above. In the event that the mobile can receive Wi-Fi signals, satellite navigation is disabled to conserve mobile device power and processing continues to step 350.

In the event that the speed at which the device is moving does not exceed the threshold, Wi-Fi information is used to determine the location of the mobile device (step 350). The mobile device may wirelessly access a particular Wi-Fi network by communicatively linking with one or more Wi-Fi access points. The mobile device communicatively links with a Wi-Fi access point by sending and/or receiving data over the particular Wi-Fi network, e.g., via an 802.11-based protocol. Each Wi-Fi access point is configured to communicate, using Wi-Fi technology and other modulation techniques, with suitable devices within its transmission range or coverage area. The collective coverage area of the Wi-Fi access points for a particular Wi-Fi network defines a Wi-Fi hotspot corresponding to that particular Wi-Fi network. Individual Wi-Fi hotspots provide a geographical coverage area or range of transmission of the corresponding Wi-Fi access points. Accordingly, a geographical position of the mobile device may be determined based on the Wi-Fi access points with which the mobile device is communicating.

An identifier corresponding to each Wi-Fi access point that a mobile device communicates with is stored for subsequent retrieval (step 360). The identifier may be a name that identifies a particular Wi-Fi network. The mobile device receives broadcast messages from all Wi-Fi access points within range advertising their identifiers. The mobile device may then select, manually or automatically, the Wi-Fi network with which to associate. The identifiers corresponding to the Wi-Fi network with which the mobile device connects are stored in the mobile device for subsequent storage at a server and retrieval.

A determination is then made to identify the Wi-Fi access points that will likely be accessed by the mobile device as the mobile device moves in a particular direction (step 370). The direction of the mobile device may be determined by identifying the different Wi-Fi access points that the mobile device interacts with over time. As the mobile device moves through different Wi-Fi hot spots, certain

Wi-Fi access points that the mobile device was in communication with may fall out of range while the mobile device may come into range with new Wi-Fi access points. Since the geographic location of the Wi-Fi access points is known, the direction of movement of the mobile device may be determined. Once the device's direction is identified, a likely route of the device may be predicted and the device may cache the identifiers for the Wi-Fi access points that are likely ahead of the device on the predicted route such that the mobile device may actively scan for these Wi-Fi access points (step 380). Subsequent network requests may be avoided by caching the identifiers of known Wi-Fi access points along the path. Accordingly, location lookups are faster, less power is consumed, and more reliable results are achieved. Processing then returns to step 310.

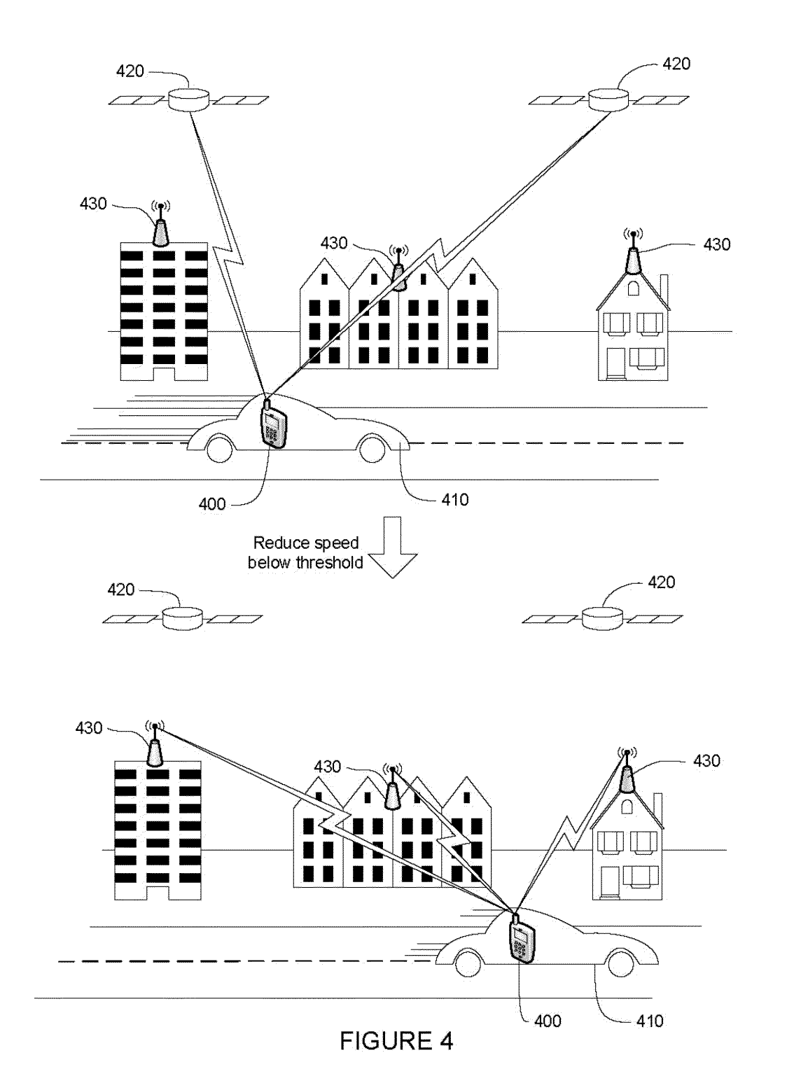

FIG. 4 is an illustration of a mobile device that is moving at a speed that falls below a threshold such that the mobile device's location is identified using Wi-Fi signals. As shown in the upper portion of the figure, a mobile device 400 is moving at a speed that exceeds a threshold. In one illustrative example, the threshold is set at 15 meters/second. However, the threshold may be selectively increased or decreased depending on specific design considerations and the location determination accuracy required for the corresponding application.

The mobile device 400 initially moves at a speed greater than 15 meters/second. This may be accomplished by a user being a driver or passenger in an automobile 410, or the mobile device 400 may be integrated in the automobile 410. Other modes of transportation may also be used to cause the mobile device 400 to exceed the speed threshold such as a bus, train, boat or motorcycle. When the mobile device 400 is moving at a speed that exceeds the threshold, a position of the mobile device 400 is determined using a satellite navigation system, as indicated by satellites 420.

In the event that the speed of the mobile device 400 is reduced to fall below the threshold, the method for determining the position of the mobile device 400 may be switched from the satellite navigation system to a Wi-Fi system (assuming that Wi-Fi signals are receivable in the area). The satellite navigation system may then be disabled. In one illustrative example, as shown in the lower portion of the figure, the automobile 410 decelerates from a speed higher than 15 meters/second to a speed less than 15 meters/second. When the speed falls below the threshold, the mobile device 400 identifies if Wi-Fi signals are receivable in the area. If so, the position of the mobile device 400 is determined by the received Wi-Fi signals generated at Wi-Fi access points 430 rather than by using the satellite navigation system. The Wi-Fi signals continue to be used to determine the position of the mobile device 400 until the speed of the mobile device 400 exceeds the threshold or until the mobile device 400 moves out of range of a Wi-Fi hot spot. Since the satellite navigation system is disabled when Wi-Fi is used for location determination, the satellite navigation system is not used to determine speed when the speed is below the threshold and Wi-Fi is accessible.

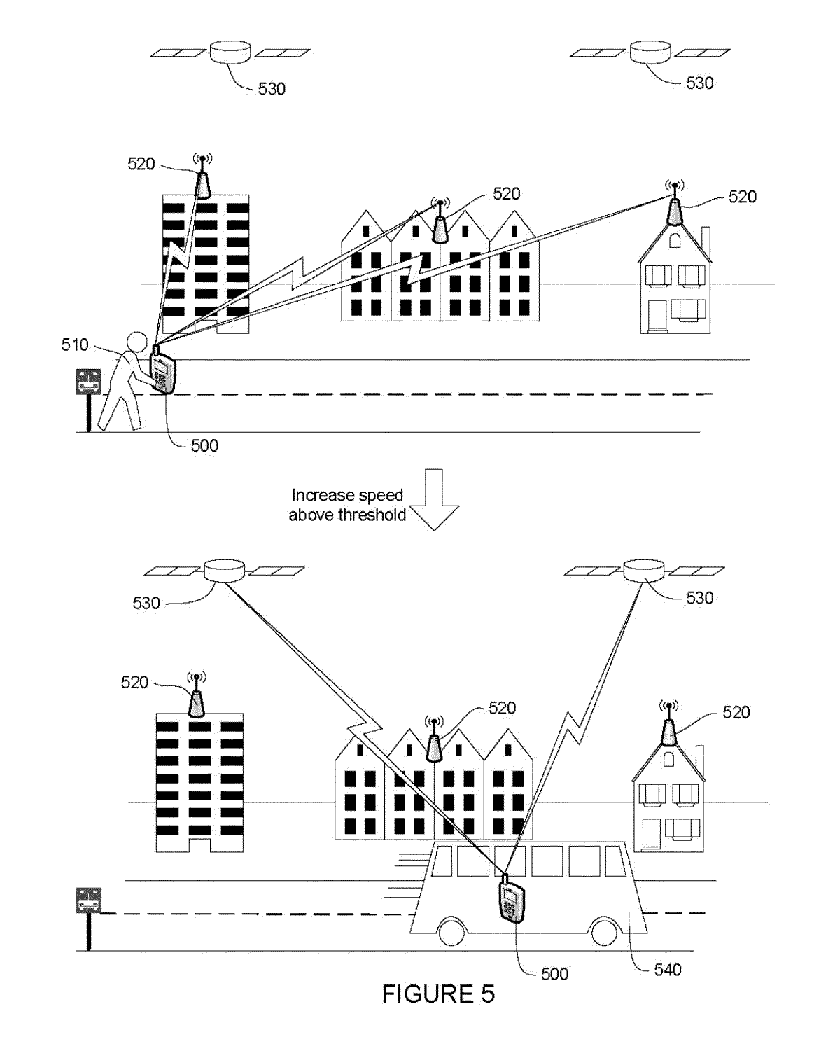

FIG. 5 is an illustration of a mobile device moving at a speed that surpasses a threshold such that the mobile device location is identified using a satellite navigation system. Initially, as shown in the upper portion of the figure, a mobile device 500 is moving at a speed that is less than a threshold. In one illustrative example, the threshold is set at 10 meters/second. However, the threshold may be selectively increased or decreased depending on specific application parameters and design considerations with respect to the accuracy required to determine device location.

GPS is more accurate than Wi-Fi for determining mobile device location, even when the device is stationary. However, in some embodiments, when the device is moving at a walking rate, sufficient accuracy may be gained for walking guidance from a series of Wi-Fi access points. Accordingly, both speed of device movement and the level of accuracy required by the application may be taken into account to determine the threshold.

The mobile device 500 may be stationary or may be moving at a speed less than 10 meters/second. For example, a user 510 may be standing still, walking, cycling while carrying the mobile device 500 or driving slowly with the mobile device 500 in the vehicle. When the mobile device 500 is moving at a speed that is lower than the threshold, a position of the mobile device 500 is determined using Wi-Fi signals generated from Wi-Fi access points 520.

In the event that the speed of the mobile device 400 increases beyond the threshold, a process for determining the location of the mobile device 500 may be changed from Wi-Fi to the satellite navigation techniques, as indicated by satellites 530. In one illustrative example, as shown in the lower portion of the figure, the speed of the mobile device 500 increases when the user 510 boards a bus 540 and the speed of the bus 540 surpasses 10 meters/second. Other examples of the speed of movement of the mobile device 500 exceeding the threshold include an automobile or train accelerating beyond the threshold with the mobile device 500 located therein, or any other type of movement that causes the speed of the mobile device 500 to surpass the threshold such as a cyclist with a mobile device on his person and riding down a steep hill. When the speed of the mobile device 500 exceeds the threshold, the location of the mobile device 500 is determined by the satellite navigation system rather than receivable Wi-Fi signals generated at the Wi-Fi access points 520. The satellite navigation system continues to be used to determine the location of the mobile device 500 until the speed of the mobile device 500 falls below the threshold and Wi-Fi signals are available to determine the location of the mobile device 500.

As described above, a mobile device location is determined using Wi-Fi signals. The location of a moving mobile device may be initially determined using a satellite navigation system such as GPS. In the event that the speed at which the mobile device is moving falls below a threshold, a determination is made whether Wi-Fi signals are receivable at the mobile device. If Wi-Fi is receivable, the Wi-Fi signals are used to determine the location of the mobile device rather than the satellite navigation system. At this point, the satellite navigation system may be deactivated. The Wi-Fi signals are continuously or repeatedly used to identify the location of the mobile device until the speed at which the mobile device is moving surpasses the threshold or until Wi-Fi signals are no longer receivable at the mobile device. Since Wi-Fi sensors of mobile devices consume less power than GPS sensors, the power consumption of the mobile device is reduced when mobile device location is determined using Wi-Fi.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A computer-implemented method comprising:
identifying an initial location of a mobile device using a satellite system;
determining, using a processor of the mobile device and using the satellite system, a first speed at which the mobile device is moving; and
determining, using the processor, whether the first speed is below a threshold;
in the event that the first speed is below the threshold, identifying a subsequent location of the mobile device using Wi-Fi signals, wherein the satellite system is not used to determine the subsequent location of the mobile device, wherein the Wi-Fi signals are received from Wi-Fi access points, each Wi-Fi access point being associated with an identifier, each identifier being stored in memory of the mobile device;
determining a direction of movement of the mobile device based on the Wi-Fi access points from which the Wi-Fi signals are received;
predicting a route of the mobile device as the mobile device moves based on the direction of movement of the mobile device and the stored identifiers associated with the Wi-Fi access points;
retrieving selected ones of the stored identifiers that correspond to the Wi-Fi access points associated with the predicted route; and
actively scanning for the Wi-Fi access points associated with the predicted route.

2. The method of claim 1, further comprising:
in the event that the first speed is below the threshold, determining whether Wi-Fi signals are received at the mobile device.

3. The method of claim 1, further comprising:
in the event that the first speed is below the threshold, disabling a satellite navigation sensor of the mobile device to conserve power consumption.

4. The method of claim 1, further comprising:
selecting the threshold such that the subsequent location of the mobile device is determinable using the Wi-Fi signals when the mobile device is moving at a speed that is less than the threshold.

5. The method of claim 1, wherein the satellite system is a global positioning system.

6. The method of claim 1, further comprising:
determining whether a second speed at which the mobile device is moving surpasses the threshold; and
in the event that the second speed surpasses the threshold, identifying the subsequent location of the mobile device using the satellite system.

7-9. (canceled)

10. A computer-implemented method for identifying a location of a mobile device using Wi-Fi signals, the method comprising:
identifying an initial location of a mobile device using a satellite system, wherein a first speed at which the mobile device is moving is higher than a threshold;
determining whether a second speed at which the mobile device is moving is less than the threshold, wherein the second speed of the mobile device is determined using a processor of the mobile device;
changing a process by which a subsequent location of the mobile device is identified from the satellite system to a system that uses Wi-Fi signals;
identifying the subsequent location of the mobile device using the Wi-Fi signals, wherein the satellite system is not used to determine the subsequent location of the mobile device, wherein the Wi-Fi signals are received from Wi-Fi access points, each Wi-Fi access point being associated with an identifier, each identifier being stored in memory of the mobile device;
determining a direction of movement of the mobile device based on the Wi-Fi access points from which the Wi-Fi signals are received;
predicting a route of the mobile device as the mobile device moves based on the direction of movement of the mobile device and the stored identifiers associated with the Wi-Fi access points;
retrieving selected ones of the stored identifiers that correspond to the Wi-Fi access points associated with the predicted route; and
actively scanning for the Wi-Fi access points associated with the predicted route.

11. The method of claim 10, further comprising:
before the changing, determining whether the Wi-Fi signals are receivable at the mobile device; and
in the event that the Wi-Fi signals are not receivable at the mobile device when the second speed is less than the threshold, identifying the subsequent location of the mobile device using the satellite system.

12. The method of claim 10, further comprising:
selecting the threshold such that the subsequent location of the mobile device is determinable using Wi-Fi signals when the mobile device is moving at the second.

13. The method of claim 10, further comprising:
after identifying the subsequent location of the mobile device using the Wi-Fi signals, determining that a third speed at which the mobile device is moving is higher than the threshold; and
identifying a further location of the mobile device using the satellite system.

14-16. (canceled)

17. A mobile computing device comprising:
means for identifying an initial location of a mobile device using a satellite system;
means for determining whether a first speed at which the mobile device is moving;
means for determining whether Wi-Fi signals are receivable;
means for identifying a subsequent location of the mobile device using the Wi-Fi signals, wherein the means for identifying the subsequent location identifies the subsequent location of the mobile device in the event that the first speed is below a threshold and in the event that Wi-Fi signals are receivable, the means for identifying the initial location of the mobile device is not used to identify the subsequent location of the mobile device wherein the Wi-Fi signals are received from Wi-Fi access points, each Wi-Fi access point being associated with an identifier, each identifier being stored in memory of the mobile device;
means for determining a direction of movement of the mobile device based on the Wi-Fi access points from which the Wi-Fi signals are received;
means for predicting a route of the mobile device as the mobile device moves based on the direction of movement of the mobile device and the stored identifiers associated with the Wi-Fi access points;
means for retrieving selected ones of the stored identifiers that correspond to the Wi-Fi access points associated with the predicted route; and
means for actively scanning for the Wi-Fi access points associated with the predicted route.

18. The device of claim 17, further comprising:
means for selecting the threshold such that the location of the mobile device is determinable using Wi-Fi signals when the mobile device is moving at a speed that is less than the threshold.

19. The device of claim 17, wherein the means for identifying the initial location is disabled when the means for identifying the subsequent location is enabled.

20. The device of claim 17, wherein, in the event that the means for determining the first speed determines that the first speed surpasses the threshold, the means for identifying the initial location is enabled and the means for identifying the subsequent location is disabled.

21-25. (canceled)
